(19) United States
(12) Patent Application Publication
(10) Pub. No.: US 2019/0259033 A1
(43) Pub. Date: Aug. 22, 2019

(54) SYSTEM AND METHOD FOR USING A DATA GENOME TO IDENTIFY SUSPICIOUS FINANCIAL TRANSACTIONS

(71) Applicant: QUANTIPLY CORPORATION, San Jose, CA (US)

(72) Inventors: Surendra Reddy, San Jose, CA (US); Vamsi Koduru, San Jose, CA (US)

(21) Appl. No.: 16/401,360

(22) Filed: May 2, 2019

Related U.S. Application Data
(63) Continuation-in-part of application No. 15/187,650, filed on Jun. 20, 2016, now Pat. No. 10,311,376.
(60) Provisional application No. 62/182,463, filed on Jun. 20, 2015.

(51) Int. Cl. G06Q 20/40; H04L 29/06; G06N 3/08; G06N 20/00; G06N 5/02

(52) U.S. Cl. CPC G06Q 20/4016; H04L 63/1425; G06N 5/02; G06N 20/00; G06N 3/08

(57) ABSTRACT

A system and method for using a data genome to identify suspicious financial transactions. In one embodiment, the method comprises receiving a data set of financial activity data of multiple participants; configuring a deep neural network and thresholds, wherein the thresholds enable detection of what is within abnormal range of financial activity, patterns, and behavior over a period of time; converting the data set to a genome containing a node for each participant among the multiple participants; computing threat vectors for each node within a graphical representation of the genome that represents behavioral patterns of participants in financial activities, including determining when a key risk indicator (KRI) value computed for a particular threshold within the data set falls outside of a dynamically determined range bounded by thresholds, wherein the threat vectors automatically identify one or more of suspicious participants and suspicious activities in a provided financial activity pattern; and determining a particular edge in the network whose behavior falls outside the dynamically determined range associated with normal activity as a suspicious.

### PRIORITY

The present patent application is a continuation-in-part of U.S. patent application Ser. No. 15/187,650, titled SYSTEM AND METHOD FOR CREATING BIOLOGICALLY BASED ENTERPRISE DATA GENOME TO PREDICT AND RECOMMEND ENTERPRISE PERFORMANCE,” filed on Jun. 20, 2016 and which claims priority to and incorporates by reference the corresponding provisional patent application Ser. No. 62/182,463, titled, “System and Method for Creating Biologically Based Enterprise Data Genome to Predict and Recommend Enterprise Performance,” filed on Jun. 20, 2015.

### FIELD OF THE INVENTION

Embodiments of the invention relate generally to using a data genome, at least in part, on history of financial transactions, customer profiles and financial data derived from plurality of data sources for automated discovery, correlation and scoring family-related transactions to improve effectiveness of transaction surveillance, suspicious activity monitoring, know your customer risk prediction, customer experience, operational efficiencies, and optimal business outcomes, customer engagement, and targeted product offerings.

### BACKGROUND OF THE INVENTION

Welcome to the age of intelligent machines and connected everything. It is a whole new world of consumerism, exploding data and devices, exponentially increasing complexity, and compliance and legal risks driven by data breaches and exposures. The customer voice and business processes now travel at the speed of light. Unpredictability and variety, driven by these evolving consumer and process dynamics found in every area of our daily lives, are the new reality. These driving forces of unpredictability are also rapidly changing new knowledge and insights, human judgment, analysis, elasticity, and the half-life of decisions and intellectual property. To keep customers engaged, educated, and entertained in this environment, business processes need to be executed in continuous real-time in response to rapidly changing customer sentiments and trends while being able to rapidly adapt to their needs and behaviors

In the banking and financial services industry, one of the business processes that needs to be performed is the identification of suspicious activities or fraudulent financial activities in the form of illegal banking transactions. Assume for example that an entity such as an individual, behavioral profile, average financial activity of person or a legal entity, performance of an application service, continuous risk profile of a customer over a period of time or the like is monitored per time unit. Assume further that major activities in incoming streamed multi-dimensional data obtained through the monitoring are recorded, i.e. a long series of numbers and/or characters are recorded in each time unit. The numbers or characters represent different features that characterize the activities in or of the entity. Often, such multi-dimensional data has to be analyzed to find specific trends (anomalies) that deviate from “normal” behavior. An Anti-Fraud System (“AFS”) and Anti-Money Laundering (AML, also known as the Suspicious Activity Monitoring (SAM) system) are typical examples of a system that performs such analysis. These systems sample financials activities of individuals or legal entities within the geographic boundaries or across boundaries. AFS and AML systems process large volume of financial activities and behaviors to detect suspicious or fraudulent behaviors by scanning all the transactions across variety of channels like ACH, international wires, cash transfers, deposits, ATM withdrawals, payments through cash cards, PAYPAL, Venmo, SQUARE cash apps etc. while trying to find suspicious patterns. If, for example, a large number of requests for transfer of small amounts of cash or electronic payments to a very large number of the same or different people or legal entities is observed, one can assume that someone is committing a financial crime like fraud or money laundering.

AML and AFS systems have to handle large volume of transactions by processing and analyzing financial activity streams to or from many (hundreds and thousands) of customers of the financial institutions. In these systems, a human analyst or investigator is assigned to analyze and adjudicate the alerts flagged by the AML and AFS systems. The case analyst or an investigator has to decide if the flagged activity is suspicious or fraudulent by examining a variety of data sources internally or externally or if some immediate action needs to be undertaken to further investigate and report this flagged report to regulators or law enforcement. However, the case analyst or investigator is incapable of understanding, compiling and processing huge amounts of data or making fast decisions because of the huge volume of data. This problem can be looked at as a data analytics problem-finding patterns that deviate from normal behavior in an ocean of numbers and information that is constantly dynamically changed. The case analysts and/or investigators cannot handle growing complexity of financial crime or fraud due to the explosion of new financial services, instruments, and methods employed or emerging from advances in financial services technologies. These new types of financial crime or fraud can develop and evolve slowly or can happen very rapidly, thereby making it very difficult for human analysts or investigators to catch them before the money changes hands. More and more new types of micro financial activities go undetected through small payments. All of these make it more difficult to effectively detect suspicious activities or fraudulent behaviors in the financial services networks.

For example, when deposits and money transfers are made at a bank, a determination is made as to whether those actions are related to money laundering or fraudulent activities. These operations are typically made by individuals or legal entities that look at a number of related facts and circumstances to make such determinations. Often times, because of the number of activities that are occurring, it is very difficult to for individuals to ascertain the full scope of actions and activities that may be involved or even the true intent behind the actions and thus be able to make a proper determination, with any reliable accuracy, as to whether the activities and the individuals involved in such activities are involved in illegal activities.

AFS and AML systems have become integral components in enforcing the financial stability within countries as well as across countries. The challenge is to perform online detection of suspicious or fraudulent activities without missed detections and false alarms. Throughout the rest of this disclosure, “online learning” is used among other things to mean an algorithm that can efficiently process the arrival of new financial activity steams (FACTS) from financial services applications, networks and channels including traditional ACH, ATM, wire transfers, cash deposits in real-time. To achieve detection of suspicious or fraudulent activities, most of existing systems or solutions use rules, e.g., sets of if-then-else statements, to verify and screen each customer, account, and activity which are developed and assembled manually after a new typology or scenario is exposed and distributed to the financial institutions. These rules need to be constantly tested and updated to meet the regulatory requirements. This approach is problematic because these systems detect only already-known typologies but fail to detect new or typologies not seen before. In addition, they do not cover a wide range of high quality, new, sophisticated emerging financial crimes that exploit emerging financial instruments, applications, credit cards, debit cards, payment services, money service banks, industrial loan companies etc.

### SUMMARY OF THE INVENTION

A system and method for using a data genome to identify suspicious financial transactions. In one embodiment, the method comprises receiving a data set of financial activity data of multiple participants; configuring a deep neural network and thresholds, wherein the thresholds enable detection of what is within abnormal range of financial activity, patterns, and behavior over a period of time; converting the data set to a genome containing a node for each participant among the multiple participants; computing threat vectors for each node within a graphical representation of the genome that represents behavioral patterns of participants in financial activities, including determining when a key risk indicator (KRI) value computed for a particular threshold within the data set falls outside of a dynamically determined range bounded by thresholds, wherein the threat vectors automatically identify one or more of suspicious participants and suspicious activities in a provided financial activity pattern; and determining a particular edge in the network whose behavior falls outside the dynamically determined range associated with normal activity as a suspicious

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 is a diagram of an exemplary network in which systems and methods consistent with embodiments of the invention may be implemented;

FIG. 2 is a diagram of another exemplary network in which systems and methods consistent embodiments of the invention may be implemented;

FIG. 3 is an exemplary functional block diagram of the pulse component of FIG. 1 and FIG. 2 according to an implementation consistent with the embodiments of the invention;

FIG. 4 is a flowchart of exemplary processing for pulse component according to an implementation consistent with the embodiments of the invention;

FIG. 5 is a flowchart of an autonomous method for data source selection, extraction, processing, classification, enrichment, and labeling of entities, relationships, rules, associations, attributes, and scores according to an implementation consistent with the embodiments of the invention;

FIG. 6 is an exemplary functional block diagram of the edge cloud component according to an implementation consistent with the embodiments of the invention;

FIG. 7 is a flowchart of exemplary processing, storing, querying the data genome according to an implementation consistent with the embodiments of the invention;

FIG. 8 is an exemplary diagram of a data genome and its components according to an implementation consistent with the embodiments of the invention;

FIG. 9 is an exemplary diagram of a computer device and its components according to an implementation consistent with the embodiments of the invention;

FIG. 10 is an exemplary functional block diagram of the edge cloud component according to an implementation consistent with the embodiments of the invention;

FIG. 11A is a data flow diagram of one embodiment of a process for generating a fingerprint in the form of a genome map;

FIG. 11B illustrates a data flow diagram of a process for accessing a customer's transaction to determine whether the customer is acting with bad intent;

FIG. 12 is a block diagram of one embodiment of a total risk score generator;

FIG. 13 is an example of a transaction score aggregator;

FIG. 14 is a data flow diagram of one embodiment of a process for predicting the next steps in a transaction;

FIG. 15 is a flow diagram of one embodiment of a process for identifying suspicious financial transactions;

FIG. 16 is an exemplary functional block diagram of scenario processing according to an implementation consistent with the embodiments of the invention; and

FIG. 17 is an exemplary functional block diagram of a threat matrix creation process according to an implementation consistent with the embodiments of the invention;

### DETAILED DESCRIPTION OF THE PRESENT INVENTION

A banking enterprise digital genome engine and method for using the same to enable banking enterprises to create the digital gene expression of the banking customers, accounts and their financial activity streams (FACTS). By creating the relevant attributes, feature vectors, statistical probabilities and recurrence metrics underlying banking transactions, banking enterprises may reduce the time and resources required to normally investigate banking transactions to determine if they are suspicious (e.g., involved with money laundering or fraudulent activities). Disclosed embodiments provide a library of typologies, behavioral scenarios, measures, metrics and indicators that can cross a variety of situations and help inform action-taking and decision-making for case analysts in the banking industry.

In one embodiment, a large number of observable quantities from the multi-dimensional input data, FACTS, are organized as “threat vectors”. Thus, unlike the prior art, in one embodiment, the detection of financial activity streams (“FACTS”) as “suspicious” or “unsuspicious” is done by the application of a financial genome combined with deep neural network algorithms that convert FACTS into a set of signals representing most relevant “threat vector” measured at regular intervals for each newly arrived data point in the embedded space.

In one embodiment, each signal comprises a plurality of “features” measured simultaneously in a time unit. The collection of features is organized as a financial genome in which various features are linked by their similarity. In one embodiment, the similarity is a measure imposed by the user. A similarity measure imposes a similarity relationship between any two features by computing all combinations among pairs of features. Clustering of these features in the similarity measures characterizes different behavioral patterns, such that all the normal activities are inside “safe” clusters and all anomalies are outside the safe clusters. Various local criteria of linkage between features and clusters lead to distinct financial genome expressions. In these financial genomes, the user can redefine relevance via a similarity measure and this way filter away unrelated information. In one embodiment, self-organization of features is achieved through an encoding process.

In one embodiment, the banking enterprise data genome disclosed herein is autonomously built though data points from traditional data sources (e.g., customer data records captured during the account opening and customer onboarding time, customer risk profiles, etc.) and alternate data sources (e.g., watchlist, sanctions lists, and negative news media) continuously curated and enriched using various technologies (e.g., cloud-based technologies) along with computed banking transaction features that are created through the application of machine learning techniques (e.g., autoencoders, generative adversarial networks, Spatio-temporal networks (STNs) and advanced analytics. In one embodiment, the financial activity genome disclosed herein employs autonomous learning, analysis, and prediction of banking and financial related transactions, as well as identifies and recommends next best actions to improve, and potentially optimize, the response of banking employees (e.g., case analysts) with reduced or minimal human intervention.

Important features of embodiments include but not limited to:
efficiency in that trillions of bytes of data can be processed in real-time using a small cluster of computers;
once the initial parameters are supplied, self-learning and autonomous and does not require additional user interaction; and
automatically generating hypotheses and tests them utilizing the machine learning and artificial intelligence methods, thereby reducing the human involvement to receiving results of suspicious activity determinations.
able to correlate otherwise unrelated parameters or features to ascertain hidden typologies, behaviors, risks, and indicators

In the following description, numerous details are set forth to provide a more thorough explanation of the present invention. It will be apparent, however, to one skilled in the art, that the present invention may be practiced without these specific details. In other instances, well-known structures and devices are shown in block diagram form, rather than in detail, in order to avoid obscuring the present invention.

As used in this application, the terms “beacon”, “engine”, “component”, “service”, and “system” and the like are intended to refer to a computer-related entity, including hardware, software, firmware, or the combination. For example, a service may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The terms “parameter” or “feature” or “threat vector” refer to an individual measurable property of phenomena being observed. A feature may also be “computed”, i.e. be an aggregation of different features to derive an average, a median, a standard deviation, etc. “Feature” is also normally used to denote a piece of information relevant for solving a computational task related to a certain application. More specifically, “features” may refer to specific structures ranging from simple structures to more complex structures such as objects. The feature concept is very general and the choice of features in a particular application may be highly dependent on the specific problem at hand. Features can be described in numerical (for example, 2019), Boolean (for example, yes or no), ordinal (daily, weekly, monthly), or categorical (SUSPICIOUS, UNSUSPICIOUS) types.

The word “exemplary” is used herein to mean serving as an example, instance, or illustration. Any aspect or design described herein as “exemplary” is not necessarily to be construed as preferred or advantageous over other aspects or designs.

Furthermore, embodiments of the present invention may be implemented as a method, apparatus, or article of manufacture using standard programming and/or engineering techniques to produce software, firmware, hardware, or any combination thereof to control a computer to implement the disclosed invention. The term “article of manufacture” (or alternatively, “computer program product”) as used herein is intended to encompass a computer program accessible from any computer-readable device, carrier, or media. For example, computer readable media can include, but are not limited to, magnetic storage devices (e.g., hard disk, floppy disk, magnetic strips, etc.), optical disks (e.g., compact disk (CD), digital versatile disk (DVD), etc.), smart cards, and flash memory devices (e.g., card, stick, etc.). Additionally, it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the subject invention

Machine learning or artificial intelligence based systems (e.g., explicitly and/or implicitly trained classifiers) can be employed in connection with performing learning, reasoning, inference, prediction, and/or probabilistic determinations and/or statistical-based determinations as in accordance with one or more aspects of the subject invention as described hereinafter. As used herein, the term “inference” refers generally to the process of reasoning about or inferring states of the system, environment, and/or user from a set of observations as captured via events and/or data. The term “inference” can be employed to identify a specific context or action, or can generate a probability distribution over states, for example. The inference can be probabilistic—that is, the computation of a probability distribution over states of interest based on a consideration of data and events. “Inference” can also refer to techniques employed for composing higher-level events from a set of events and/or data. Such an inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines, etc.) can be employed in connection with performing automatic and/or inferred action in connection with the subject invention.

Furthermore, in one embodiment of the digital genome map may be viewed as analogous to that of biological genome. In one embodiment, this data genome structure provides a detailed encoding of the entity's (an individual person or a legal entity) behavioral, occupational, transactional, conversational, as well as risk vectors. Using this novel data encoding technique, its is very efficient to compare to entities for similarities by computing the overlap scores between the first and the second entity digital gene expressions. In one embodiment, financial genome expressions are encoded using the Sparse Distributed Representations (SDRs).

### Overview

Briefly described, digital genome system or framework as well as various systems and methods of use and interaction therewith are described. In one embodiment, embodiments of the invention provide an automated way to codify the customer profiles, behavior, and motivations related to banking and/or financial transactions by continuously measuring, correlating, and discovering hidden relationships among various metrics, attributes, causal relationships, and networks and display genomic findings via applications without a priori knowledge of machine learning or statistical techniques.

According to one embodiment, the system automatically scans the specified data sources to identify the relevant attributes, characteristics, feature vectors, metrics, and properties within the given data source utilizing machine learning techniques like feature selection and correlations combined with the subject matter experts (SMEs) augmented intelligence to identify features related to banking transactions, the associated accounts, and the account holders, and their networks. Systems are disclosed to facilitate discovery and definition of metadata such as properties, attribute, or elements, some of which are specified as values and set of scenarios and rules to compute and transcription of the banking customer profiles as the enterprise genomic structure. Once key components of the genomic structure are defined, it can then be stored in a location (e.g., the cloud at a data source (e.g., a database)) for access.

According to another embodiment, a bit data genome engine is associated with the semantic data source. The bit data genome engine can execute specified algorithms or functions to identify and score new transactions. This can be accomplished by retrieving specified data from the data source, extracting the features from the data sources, and using these features to predict and infer causal relationships within banking-related transactions. According to an embodiment, a learning, analytics, and prediction engine can be proactive and automatically generate new parameters and models to facilitate real time enrichment of the banking data genome. Furthermore, the learning, analytics, and prediction engine can automatically create new rules and models and perform adjustments in order to support newly discovered outages that are identified.

According to another embodiment, a cloud based semantic data store is part of a database management system or server remote or proximate to applications that interact therewith. The banking data genome engine uses efficient storage, management, and security associated with such systems especially in plurality of data structures like graphs (e.g., knowledge graphs), columnar, and row data structures (e.g., fingerprints) that are all in integrated through the single interface.

According to another embodiment, a system and method represents organizational entities, attributes, and relationships related and involved in banking/financial transactions in one or more digital genome maps. In one embodiment, a banking digital genome map provides a representation of organizational entities, relationships and interactions among those entities. Particular instances of a data genome can serve as a model for a banking industry and serve as a reference to represent one or more relationships, interactions, and transactions among and between such entities and individuals.

According to another embodiment, there is provided a computer implemented method of detecting anomalies or suspicious activities in multi-dimensional financial activity streams (FACTS) comprised of multi-dimensional data points, the method including: processing the multi-dimensional data points to obtain features and a threat matrix, a sparse data representation of features mapped into a connected graph; applying one or more auto encoders to compute threat coordinates of a newly arrived data point; and determining whether the newly arrived data point is suspicious or normal based on its computed coordinates.

In one embodiment, the digital enterprise genome uses traditional data obtained from banking transactions, accounts and customers, and alternate data such as, for example, social media profiles and community based data continuously curated and enriched and computed insights, through continuous discovery and enrichment of patterns and insights discovered from these data sets.

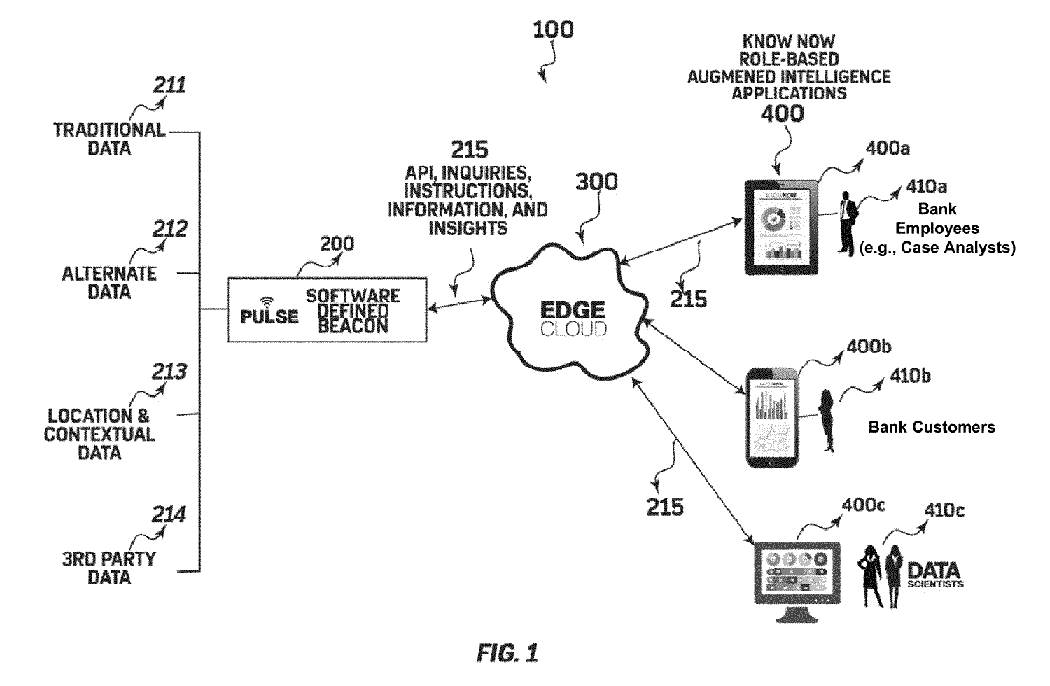

FIG. 1 is a diagram of an exemplary network 100 in which systems and methods consistent with the principles of embodiments the invention may be implemented. The system 100 provides a framework for development, implementation, and execution of enterprise data genome system 100 can include pulse contextual data related to business transactions i.e. identify and gather relevant data gathering and local learning component 200 and plurality of data sources 210 including traditional data 211, alternate data 212, location and contextual 213, and curated third party data facts, dimensions, census, demographic, psychographic, economic, emotional, and cognitive data 214.

In one embodiment, software defines contextual gathering component, pulse 200, can be a generic computer program or computer program product as defined herein, including a plurality or executable instructions for performing one or more functions. One of those functions can include pulse, a software defined beacon, in which the processing characteristics of these processes may be created automatically based on the context in which the pulse 200 is operating and facts and dimensions 214 known to the pulse 200 at that point in time. In one embodiment, upon connecting to edge cloud 300 using the APIs 215, pulse 200 receives up to data programmatic instructions, information, and insights 215 sent to pulse 200 from edge cloud 300 to execute on the pulse, a software defined contextual data gather component, 200. A pulse 200 component collects data from the defined data sources 210 and enriches it with the location and contextually relevant data and send the computed data records 215 related to banking transactions to the edge cloud 300 via APIs 215. APIs, inquiries, instructions, information, and insights 215 component provide a simple and uniform semantic interface to query the knowledge and information from the edge cloud 300.

In FIG. 1, data sources 211, 212, 213, and 214 are computer accessible components that provide and/or stores data from banks or other institutions involved in transactions or that are sources of data that may be relevant in the classification of transactions as suspicious or representing illegal or otherwise bad behavior. Traditional data sources 210 are currently used by many banking businesses to run their business operations effectively. Examples of this traditional data include, but not limited to, data from internal customer relationship management (CRM), enterprise resource planning (ERP), ecommerce, relational database management system (RDBMS) warehouses and other enterprise systems. These sources may be used to banking transaction information that can be used to start the analysis. In addition to traditional data sources available internally within the banking businesses, wide variety of external data sources, including but not limited to, external traditional third-party customer and market data sources are also available through companies that specialize in providing these services. Options include, for example but not limited to, Experian Information Solutions, Inc. household, demographic and segmentation data; and Dun & Bradstreet, Inc. business firmographic data. Compiling this information into a single view and running analytics on the dataset generates the outline of the customer genome: gender, history data, birthdate, preferences and more, that may be useful in evaluating whether banking transactions are suspicious.

Alternate data 212 refers to data not commonly used today for segmentation and personalization, as well as data from the third party data providers such as, but not limited to, LexisNexis, Dow Jones, Dun & Bradstreet, RDC, in addition to directly accessing several publicly available data sources such as, but not limited to, OFAC, SDN, PEP lists. Integrating the third party data sources helps banking businesses derive deeper insights to better understand the behavior of individual customers or legal entities.

Location and contextual data 213 is location based, contextually gathered information may be computed and generated by the pulse 200 or may be received from the external sources 213. Pulse component 200 may enrich the data collected from traditional data sources 211 and alternate data sources 212 with the location and contextual data 213 implemented according to the principles of the subject invention. This may include information such as lists of certain sanction lists (e.g., a sanction list of countries known to facilitate illegal financial activities, a sanction list of individuals known to be involved in illegal financial activities, etc.) or other information related to those known to be involved in suspicious banking transactions.

In one embodiment, APIs, inquiries, information, and insights component 215 is single interface that may be used to send gathered data using secure mechanisms protecting data in transit via interoperable, open secure authentication and authorization standard mechanisms. One exemplary interface is representational state transfer (REST) APIs using JavaScript Object Notion (JSON). For example, when a transaction is determined to be suspicious, the information may be provided with an explanation of the pattern of activities and/or individuals involved in a transaction was determined to be suspicious.

Accordingly, traditional data sources 211 can be a computer database residing on a computer readable medium or part of a database management system or server. Data gathered by pulse 200 and is stored in an organized fashion 305 to facilitated search and retrieved of particular data. There are an infinite number of ways to organized data in source 305. In one embodiment, all features and context that are extracted are organized as a multidimensional database wherein data storage structures include NOSQL data structures 305 comprising dimensions, facts, rules, associations, and measures to name a few. However, it should be appreciated that other types of databases and storage structures are contemplated by and considered within the scope of the present invention.

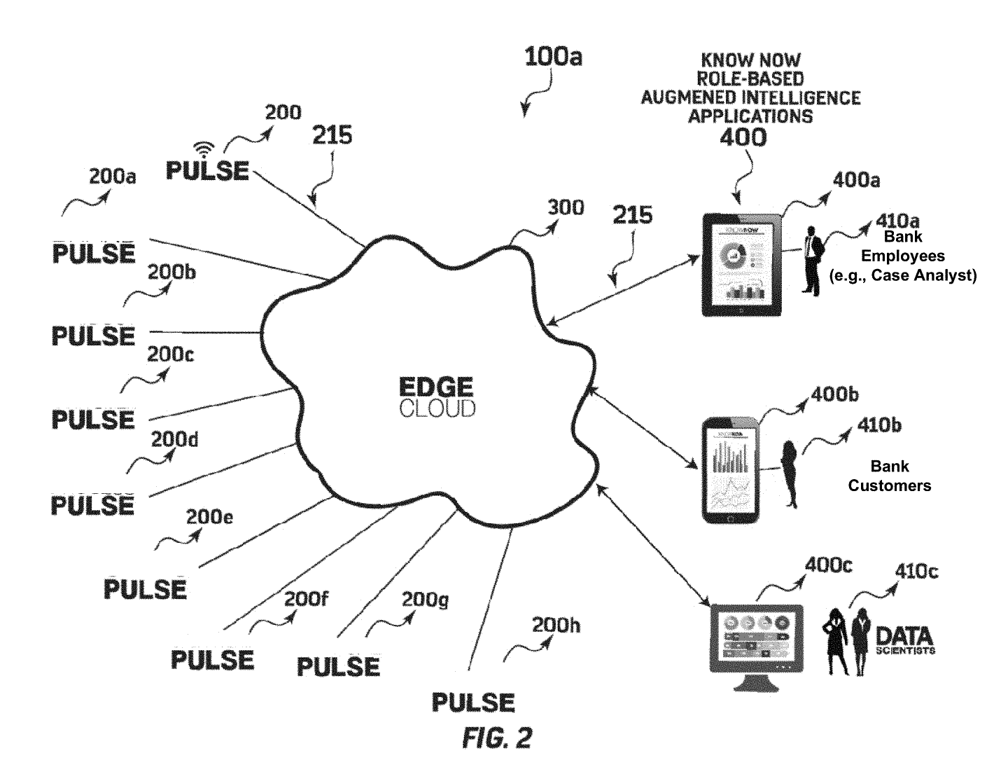

FIG. 2 is a diagram of another exemplary network in which systems and methods consistent with the principles of the invention may be implemented. According to one aspect of the invention, pulse component 200 is organized to run on different servers as different 200a-200h to collect relevant to evaluate banking-related transactions from banking institutions and data sources in response to data gathering instructions delivered from the edge cloud 300. While pulse components 200a-200h are shown as separate entities, it may be possible for one or more of pulse components 200a-200h to perform one or more of the functions of another one or more of pulse components 200a-200h. It may also be possible for a single one of the pulse components 200a-200h to be implemented as two or more separate (and potentially distributed) pulse components.

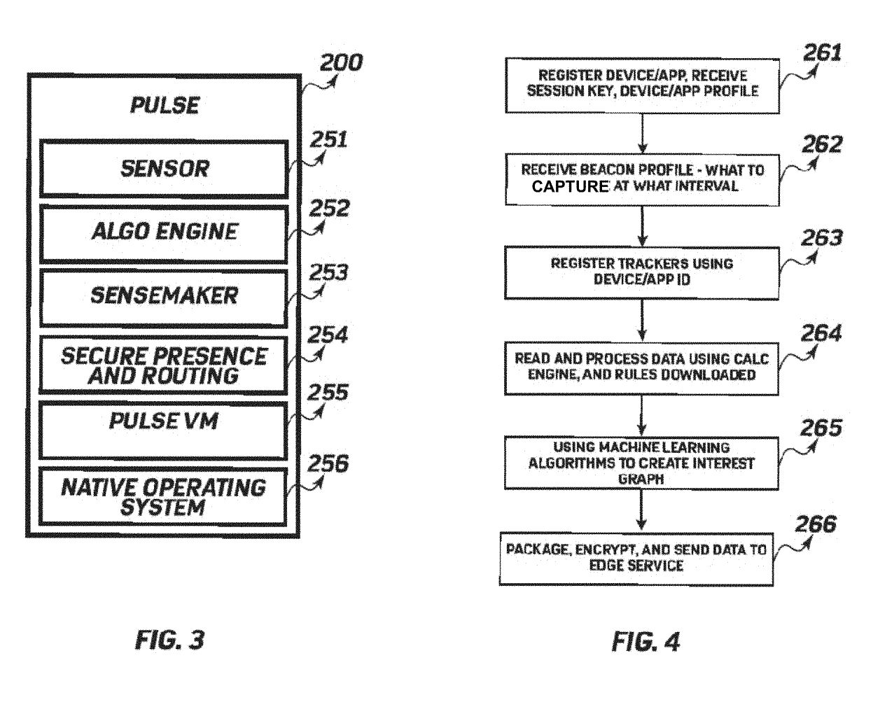

FIG. 3 is an exemplary functional block diagram of one embodiment of the pulse component 200 of FIG. 1 and FIG. 2, which may correspond to one or more pulse components 200a-200h. The pulse component 200 may include a data sensor 251, algorithmic engine 252, sensemaker 253, secure presence and routing 254, pulse virtual machine (VM) 255, and native operating system 256. The native operating system 256 may include a computing device 600 that includes different devices that may be able to capture or otherwise collect the necessary information. In one embodiment, computing device 600 includes one or more conventional processors or microprocessors 601 that interpret and execute instructions. Main memory 602 may include a random access memory (RAM) or another type of dynamic storage device that stores information and instructions for execution by the processor(s) 601. Non-volatile storage 603 stores static information like program code and instructions for use by the processor 601. Storage device 604 may include magnetic and/or flash medium and its corresponding drive. Input device(s) 606 may include one or more conventional mechanisms that permit an operator to input information, such as a keyboard, a mouse, a pen, voice recognition and/or biometric mechanisms. Output device(s) 605 may include one or more conventional mechanisms that output information to the operators, including a display, a printer, a speaker etc. Communication device 607 may include any communication interface that enables the computing device 600 to communicate with the other devices and systems. In one embodiment, communication device 607 comprises a network communication interface to communicate over a network (e.g., the Internet, etc.).

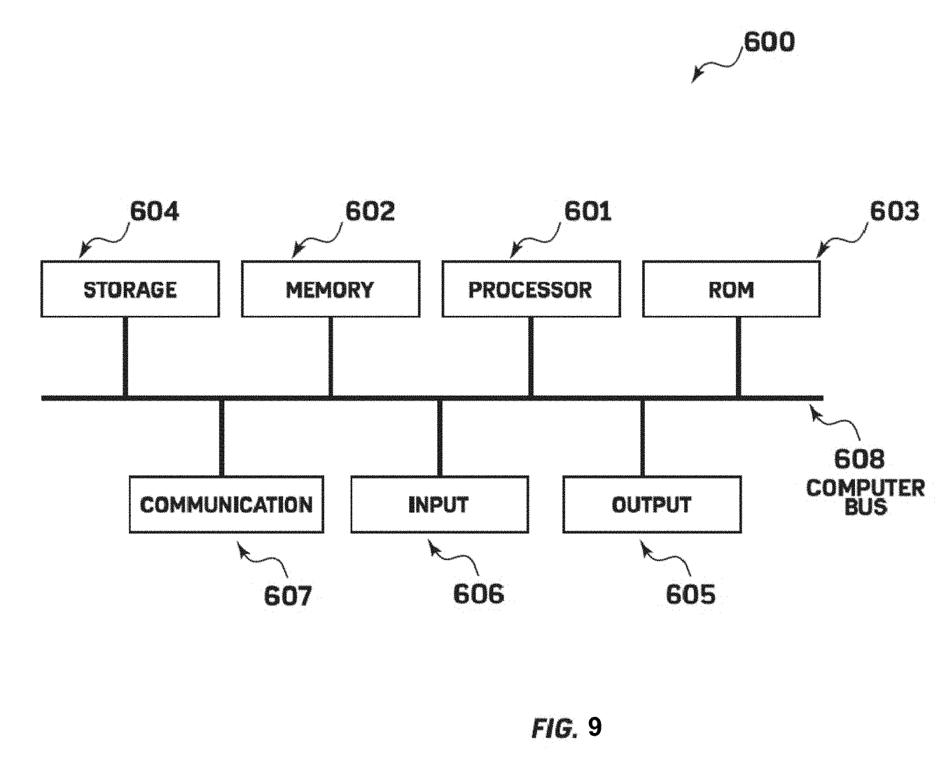

The pulse component 200 herein performs certain data sensing, processing, and sensemaking operations. Sensemaking operations include inputs confirming relationships and characterizations into the genome. The pulse component 200 may perform these operations in response to computing device 600 shown in FIG. 9 executing the on the processor 601 instructions downloaded from the edge cloud 200 into the computing device 600 memory 602. In one embodiment, pulse component 200 performs certain operations as shown in the FIG. 4, which is functional block diagram of a pulse component 200. As shown in FIG. 4, in one embodiment, pulse component 200 performs tasks register device/application, receive session key, and device/application profile 261, receives beacon profile 262 applying the information to collected register trackers and sensors 653 using the device application/ID, read and process data using the algorithmic engine and downloaded rules 654, using machine learning code downloaded from the edge cloud 300 to create the interest graph 655, and finally package, encrypt, and transmit the collected data securely 656 to the edge cloud 300. The computer bus 657 can be any of several types of bus structure(s) including the memory bus, memory controller, a peripheral bus, local bus, or an external bus using any variety of available architectures available including, but not limited to, Peripheral Component Interface (PCI), Universal Serial Bus (USB) etc.

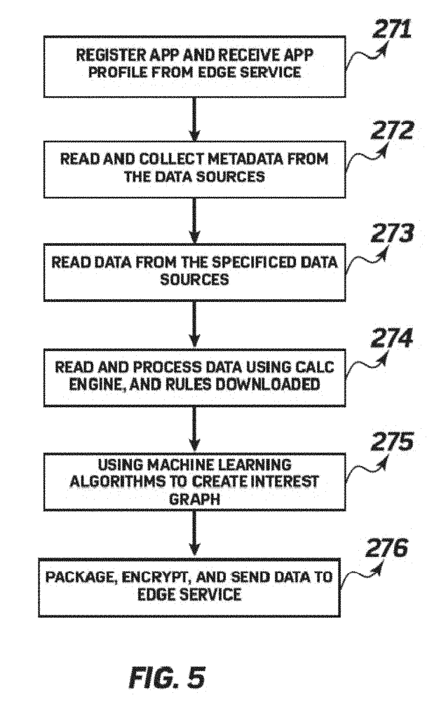

FIG. 5 is a flowchart of an autonomous method for data source selection, extraction, processing, classification, enrichment, and labeling of entities, relationships, rules, associations, attributes, and scores according to an implementation consistent with the teachings herein. In other embodiment, the pulse component 200 autonomously performs the operations outlined in the FIG. 5. These operations include but not limited to register application and receive application profile from the edge service 271, read and collect meta data from the data sources 272, read data from the specified data sources 273, read and process data using algorithmic engine and rules downloaded 274, using machine learning code downloaded from the edge cloud 300 to create interest graph 275, and package, encrypt and send data to the edge cloud securely 276.

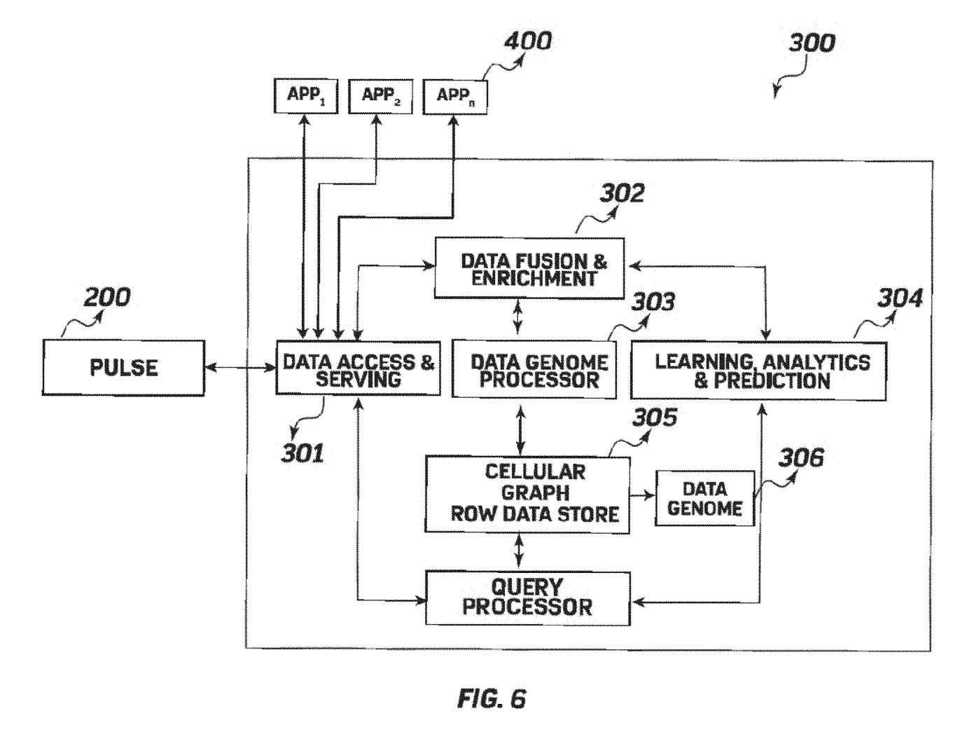

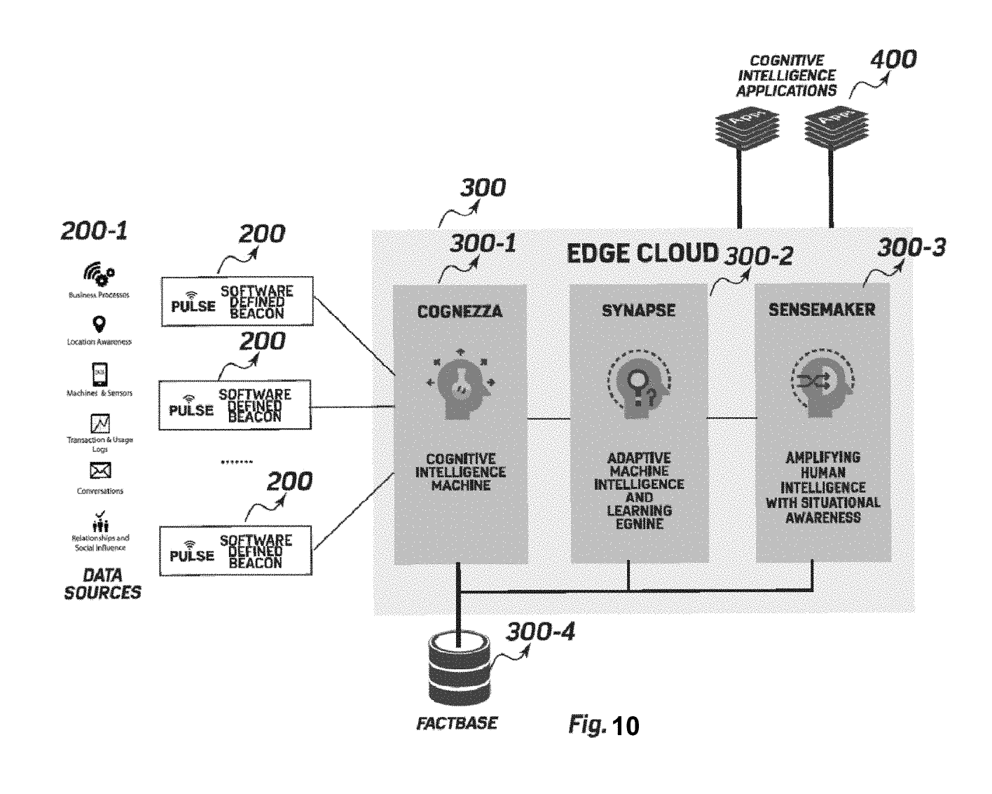

FIG. 10 is an exemplary functional block diagram of the edge cloud with subcomponent according to an implementation consistent with the teachings herein. These subcomponents include cognitive intelligence machine 300-1, adaptive machine intelligence and learning engine 300-2, sensemaker 300-3, and factbase 300-4. Factbase 300-4 component stores all facts and dimensions learned via data process, enrichment and prediction process as outlined in the FIG. 6. Factbase 300-4 can be realized using off-the-shelf relational database products or graph data store engines. The internal processing mechanisms to realize the inner workings of this process are outlined in the FIG. 6. The edge cloud 300 component expose all facts and dimensions via API for creating cognitive applications 400.

FIG. 6 is an exemplary functional block diagram of the edge cloud component according to an implementation consistent with the principles of the invention. Edge cloud 300 may include data access and serving component 301, data fusion and enrichment component 302, data genome processor 303, learning, analytics, and prediction component 304, cellular, graph, and row data storage component 305, data genome data structure 306, and one or more query processors 307 according to an implementation consistent with the principles of the invention. Data access and serving component 301 may receive requests and queries from pulse component 200 and/or know now augmented intelligence applications 400. Pulse component 200 and Know now augmented intelligence component 400 may communicate with data access and serving component 301 of the edge cloud 300 using exemplary REST API and messages encoded in JSON. However, pulse component may understand other communication protocols like standard protocols known in the industry like TCP/IP, XMPP, MQTT, and COAP and standard message formats like XML, CSV etc.

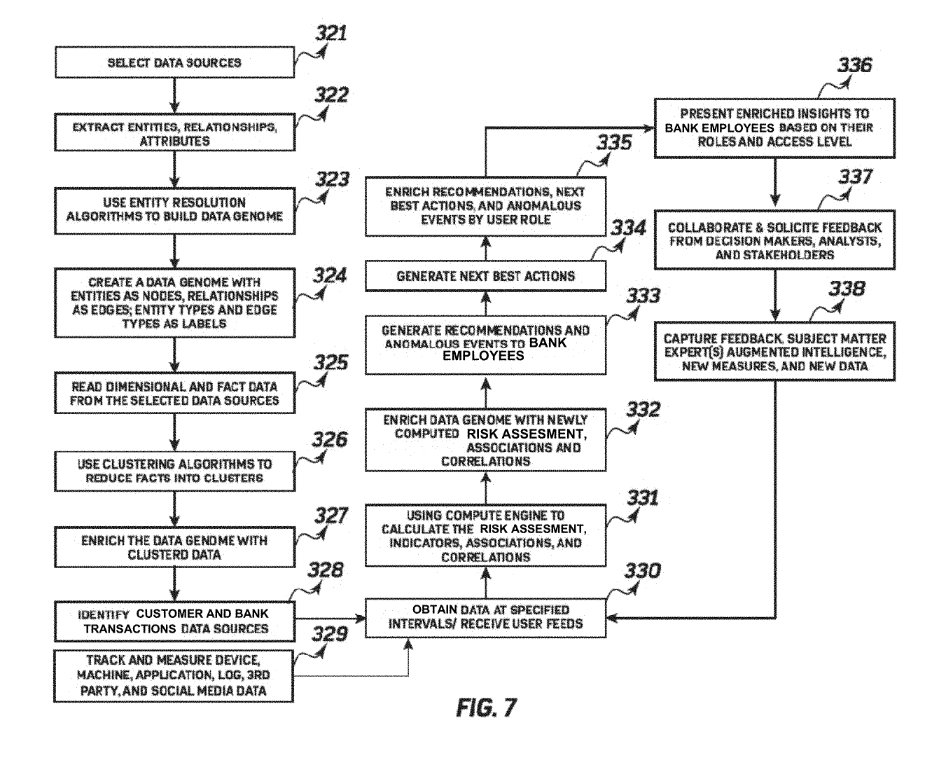

FIG. 7 is a flowchart of exemplary processing, storing, querying the banking data genome according to an implementation consistent with the principles of embodiments of the invention. As shown in the FIG. 7, the exemplary edge cloud implementation in consistent with the principles of this invention may perform select data sources 321 from the edge cloud data source 305; extract entities, relationships, and attributes 322; using entity resolution algorithms 323 to build data genome 306; create a data genome 306 with entities as nodes, relationships as edges, entity types and edge types as labels 324; read dimensional and fact data 325 from the data source 305; use clustering algorithms to reduce plurality of facts into similar groups or clusters 326; enrich the data genome 306 with the new insights derived from the clusters 327; identify customer and bank transactions, data sources, and algorithms to compute the models 328; track, measure and enrich models 329 with alternate data 212, location and contextual data 213, and third party 214; obtain data at specified intervals 330; using data fusion and enrichment component 302 to calculate the risk assessment, measures, associations, and correlations 331, enrich data genome 306 with newly computed risk assessments, measures, associations, and correlation scores 332; based on the insights and information available in the edge cloud data source 305 generate recommendations and anomalous events to banking employees 333; generate next best actions based on the location, contextual, user profiles, and roles 334; enrich the recommendations based on the information generated in 333 and 334 by use profiles and roles 335; deliver the role-based insights and information 336 to the bank employees 410a via know now augmented intelligence applications 400; receive collaboration feedback and new information gathered from the bank employees 410a using role-based micro-applications 400a-400c; and update the augmented intelligence 338 received from the bank employees 410a (e.g., case analysts).

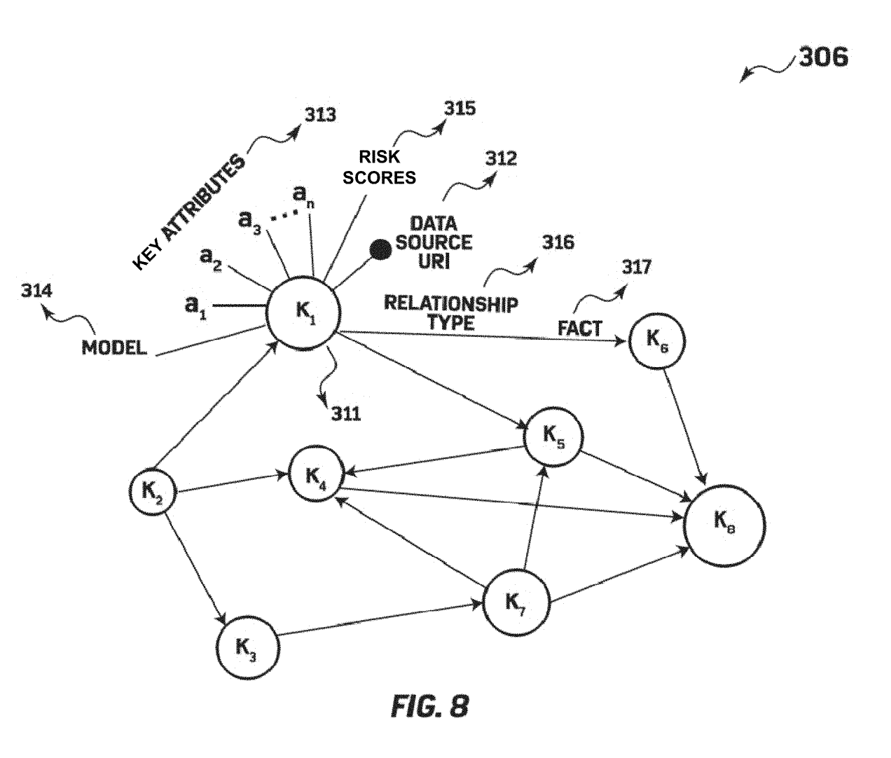

FIG. 8 is an exemplary diagram of a data genome and its components according to an implementation consistent with the principles of the invention. As shown in FIG. 8, data genome 306 is realized as a semantic network of entities as nodes K₁-K₈, relationships and facts as edges in the network. Each node may contain attribute map a1-an, risk scores 315, data source universal resource identifiers (URI) 312 and model 314 that describes the behavior of the entity computed using the historical and real time data sources 210. Each edge may capture relationship type 316, and facts 317.

Bank employees 410a in FIG. 1 and FIG. 2 may select a specific area of the data genome 306 in FIG. 8 to drill down further into the details. Details are personalized based on a user role and profile information for a particular banking employee. Banking institutions can also use a Know Now Augmented Intelligence system to identify connections between customer genomes. These links can be the basis for developing recommendation strategies for dealing with multiple parties in suspicious activities. In one embodiment, a know now augment intelligence application consists of, but not limited to, left menu bar with all options available for the given business user role and profiles; responsive menu option for devices with limited display area which is automatically detected by the application; user profile and account information; user specific communication tools; user defined widgets; genome map for the given role and scenario; collaboration channel for users; and recommendations and next best actions personalized for the given user. Know now augmented intelligence application may be configurable by the business users.

### More Detailed Embodiments

In the following description, components, modules, logic and blocks perform operations using processing logic that may comprise hardware (e.g., circuitry, dedicated logic, etc.), software (such as is run on a general purpose computer system or dedicated machine), firmware, or a combination of the three.

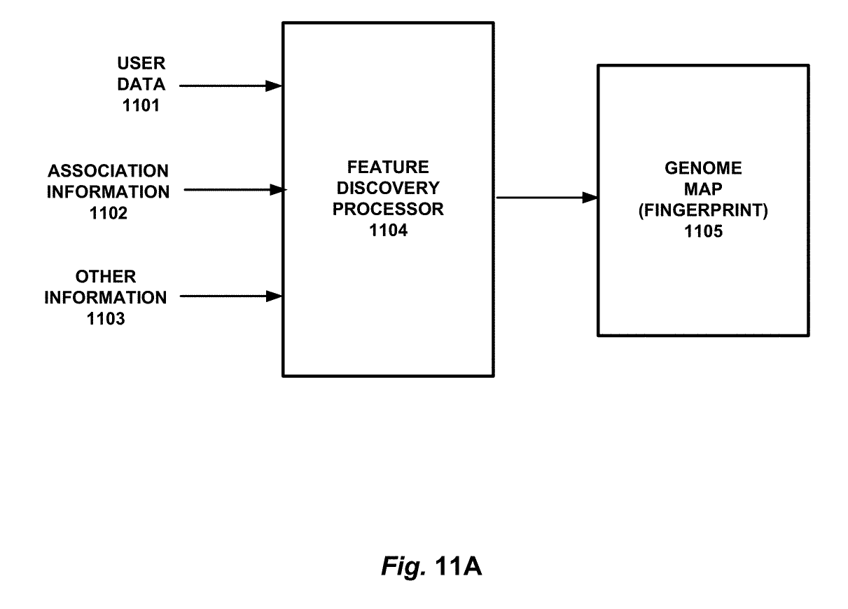

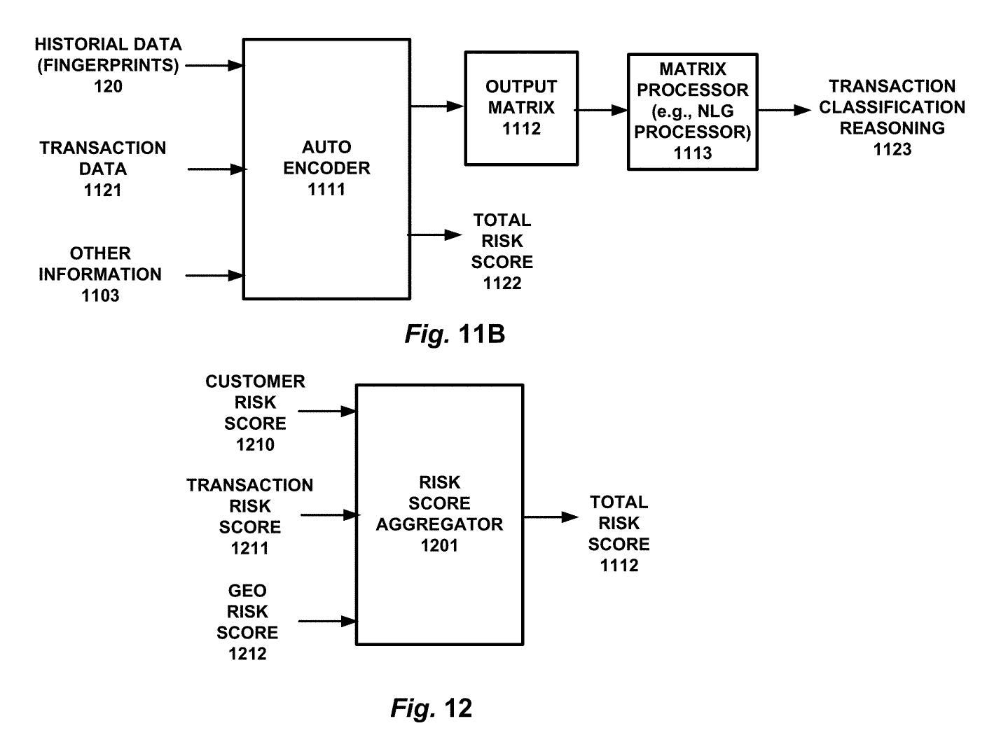

FIG. 11A is a data flow diagram of one embodiment of a process for generating a fingerprint in the form of a genome map. Referring to FIG. 11A, a feature discovery processor 1104 receives inputs, and in response to those inputs, generates genome map 1105. In on embodiment, inputs are user data 1101, association information 1102, and other information 1103. User data 101 includes information about the banking customer. This may include information the customer provided to the banking institution when they opened an account, including personal data (e.g., location (e.g., residence), age, bank accounts and their location, financial sources, occupation, ownership structures, associations with other entities or individuals. Association data 1102 includes information indicative of the associations, personal or non-personal, that the banking customer has. In one embodiment, these include one or more of accounts with other banking or financial institutions, connections to sanctioned individuals or entities, relationships with other businesses or entities, indirect relationships to individuals or entities, etc. In one embodiment, this information is generated using entity-resolution algorithms. Other information 1103 includes any information that is related or useful in assessing whether the banking customer would perform suspicious or bad financial transactions. This could include news, commercial data, analytics and insights for business available from, for example, the web, social media, companies (e.g., Edgar, Dunn & Bradstreet, etc.) about the individual, as well as other activities in which an individual is involved, interbank chat history, website text capture, search keywords, keywords extracted from the adverse media through crawling the public news web sites or search engines (e.g., Google, Yahoo, and Microsoft).

In response to the data inputs, feature discovery processor 1104 performs feature learning to find common features and distinct features of the individual that are indicative of unique behavior patterns that are signatures of bad intent. That is, the feature discovery process performed by processor 1104 identifies features of the individual's behavior that indicates a certain likelihood that they will act with criminal intent and/or bad faith.

In one embodiment, the feature vector discovery process performed by processor 1104 identifies latent, or hidden, features that are only implicitly described. This feature discovery method comprises several processes that include receiving, at the one or more computer systems performing the process, a data set of financial activity streams (FACTs) of multiple participants including individuals, legal entities, correspondent banks, respondent banks, industry loan companies (ILCs), money serving banks (MSBs), payment processors, etc. Note that in one embodiment a subset of these is used or additional data is used. In one embodiment, processor 1104 first computes metrics and associated tolerances, where the tolerances enable dynamic learning of what is within a range of normal over a period of time. Processor 1104 then converts the data set to a genome representation (e.g., a map), containing a node for each participant among the multiple participants. Feature vectors are then computed for each node within the financial genome representation. Then, processor 1104 determines when the threat vectors are computed for a particular data point within the data set falls outside of a pre-calculated normal range bounded by the associated risk tolerances. In one embodiment, the determination automatically identifies in a provided financial activity streams (FACTs), without requiring an input of a priori models for normal or abnormal behavior. Thus, complex aspects of suspicious activity patterns identified within the data set are converted into threat vectors.

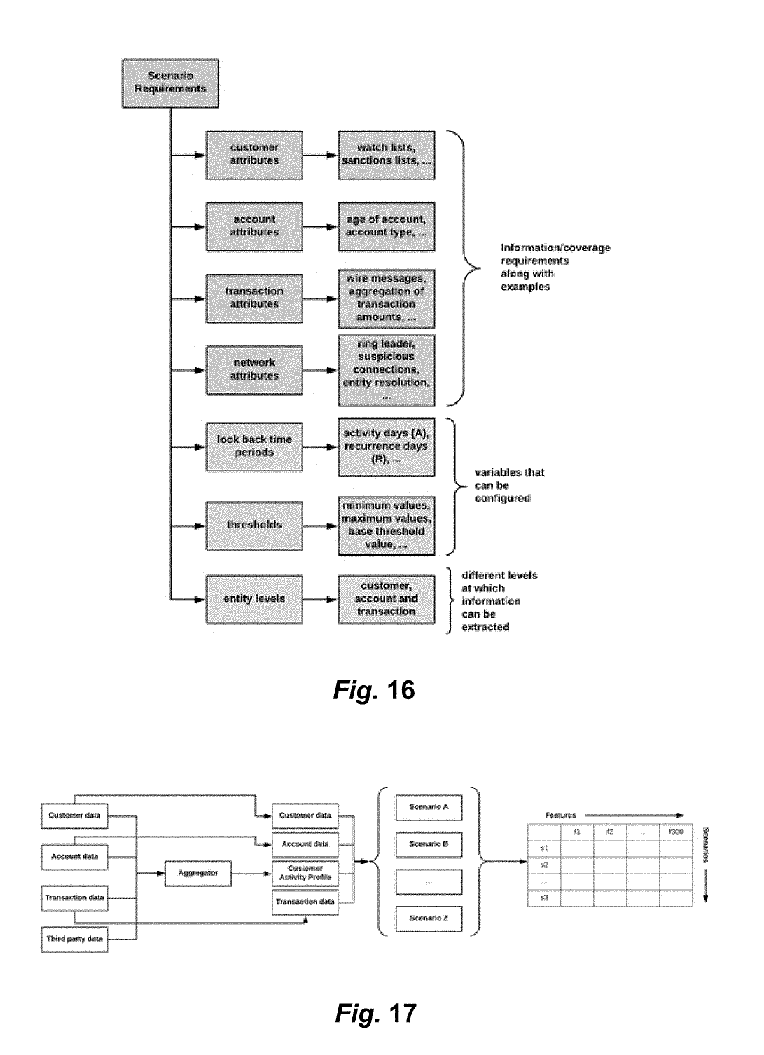

Scenarios help the end user to define various types of behavior one would use to detect suspicious activity. In one embodiment, scenarios are user-defined behaviors/typologies that evaluate and examine a customer's profile, transactions, account history, and other underlying customer attributes to generate alerts based off of the thresholds set, to indicate suspicious or money laundering activities. In one embodiment, processor 1104 executes an application that helps configure scenarios, update or manipulate thresholds for scenarios and manage the computations for these scenarios. FIG. 16 illustrates one embodiment of information obtained and used by processor 1104 for discovery, clustering and knowledge graph representation of the scenarios. Scenarios are the key to the transformation of the raw customer, account, and transaction data to features. These features are fed as input data to the machine learning models.

In one embodiment, processor 1104 generates threat vectors. In one embodiment, threat vectors are used to training machine learning models. In one embodiment, a matrix of threat vectors is generated. FIG. 17 is a flow diagram of one embodiment of a processor for threat matrix generation. Referring to FIG. 17, customer data, account data and transaction data to extract aggregates and various attributes to help compute the values for the corresponding scenarios. Additionally, third-party data is also leveraged to further enrich the information. The customer data, account data, transaction data, and third-party data are aggregated by an aggregator to create a customer activity profile. For the customer data, account data, transaction data and third-party data, scenarios are computed at various levels: customer level, account level, and transaction level. The scenarios (e.g., s₁, s₂, . . . , sₙ) have features (e.g., f₁, f₂, . . . , f₃₀₀).

In one embodiment, a threat vector, a sparse data representation of the entities, and their activities, is received as a data input, and the genome is generated. In one embodiment, the genome is generates and includes a computer based graph representation of subjects, predicates, and objects (via one or more computer systems). In one embodiment, the anomaly is automatically identified as a potentially fraudulent activity or suspicious activity and provides enhanced detection of suspicious activity or fraudulent behavior.

In one embodiment, feature discovery processor 1104 constructs genome map 1105. Genome map 1105 is a knowledge map that acts as a fingerprint to uniquely identify the customer's behavior from others. The generation of knowledge maps is well-known in the art; however, knowledge maps generated to include a banking customer's behavior for use in determining a certain likelihood that they will act with criminal intent and/or bad faith is an unconventional use.

Once the fingerprint for a customer has been generated, the fingerprint is used to determine the probability of whether each new transaction being conducted by the customer is a bad act (e.g., whether the customer is acting with bad intent). FIG. 11B illustrates a data flow diagram of a process for accessing a customer's transaction to determine whether the customer is acting with bad intent.

Referring to FIG. 11B, auto encoder 1101 receives historical data 1120 of a customer along with transaction data 1121 associated with a new transaction being performed by the customer. In one embodiment, historical data 1120 includes the customer's fingerprint. In one embodiment, the historical data is not limited to the customer but also that of other individuals or entities for which the institution has data. Fingerprints are able to be ascertained around various ontologies, typologies, and behaviors, thus allowing for, but not limited to, complex inference of inherent risk or likely behaviors. With the above embodiment, auto encoder 1101 provides a statistical pattern classification for detecting anomalous financial activity patterns or events through the use of a genome algorithm. When the data set is received, auto encoder 1101 clusters data points from the received data set to generate model clusters having normal cluster values. Then, the encoder 1101 determines whether a threshold baseline for a minimum number of metrics for anomaly evaluation is established. Next, when the threshold baseline has not been established, auto encoder 1101 (a) stores the computed threat vectors; (b) determines whether a pre-set minimum number of signals have been detected to meet the baseline minimum number of thresholds for threat evaluation; and (c) converts the next data block into a genome.

After the transformation of raw data into feature vectors, the next operation is to understand the distribution of the feature vectors. This is an important step to check for any biases in the data. In one embodiment, certain validation checks are: (a) If the data favors any particular groups or certain individuals; (b) if there is an imbalance in the dataset with respect to gender or race or an occupation, the chances of the model learning these biases are high; (c) if the sample selected to train the models, does not represent the entire population of the dataset, sample biases could be introduced. If the model has been trained on data where women have not laundered any money then it is likely that the model can draw wrong inferences creating stereotypes or prejudices; and (d) If there are strong correlations amongst variables in the dataset provided by the bank to train the models, this could affect the results too. In one embodiment, auto encoder 1111 removes any such data from the sampled signals using clustering technique.

In response to the inputs, auto encoder 1111 generates a total risk score 1122 indicating the risk associated with the new transaction and an output matrix 1112. In on embodiment, total risk score 1122 is an aggregation of multiple risk scores. In one embodiment, the multiple risk scores aggregated into total risk score 1122 is a customer risk score indicating a risk level associated with this customer of the new transaction, a transaction risk score indicating a risk level associated with the new transaction, and a geo risk score indicating the risk level associated with the location of the transaction as well as the destination. FIG. 12 is a block diagram of one embodiment of a total risk score generator. Referring to FIG. 12, risk score aggregator 1201 receives customer risk score 1210, transaction risk score 1211, and geo risk score 1212 and aggregates those into total risk score 1112. In one embodiment, risk score aggregator 1201 comprises one or more processors and/or circuitry to combine customer risk score 1210, transaction risk score 1211, and geo risk score 1212 together. In one embodiment, each of customer risk score 1210, transaction risk score 1211, and geo risk score 1212 are weighted (i.e., a weight is applied to each score) and the weighted risk scores are added together. In one embodiment, customer risk score 1210, transaction risk score 1211, and geo risk score 1212 are all weighted differently. In another embodiment, two or more of customer risk score 1210, transaction risk score 1211, and geo risk score 1212 are weighted the same while the third risk score is weighted differently.

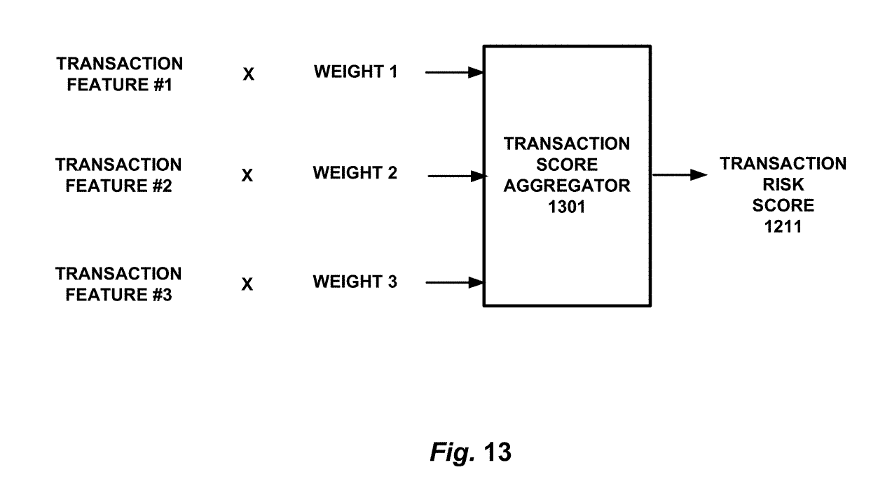

In one embodiment, one or more of customer risk score 1210, transaction risk score 1211, and geo risk score 1212 is generated by aggregating multiple feature scores associated with features that have been identified for the transaction. In one embodiment, the multiple feature scores associated with features that have been identified for the transaction are weighted and then combined together. FIG. 13 is an example of a transaction score aggregator. Referring to FIG. 13, features 1-3 of a transaction (e.g., 0.5 for money transfer greater than $10,000.00, 0.9 for an originating customer on sanctions list, 0.7 for a beneficiary customer on sanctions list, etc.) are weighted by multiplying weights 1-3 (5, 10, 7), respectively. These weighted values are input to transaction score aggregator 1301 which combines them into transaction risk score 1211. In one embodiment, transaction score aggregator 1301 adds the weighted values together. Note that they are other ways to combine the weighted scores together.

In one embodiment, customer risk score 1210 and geo risk score 1212 are generated in similar ways to transaction risk score 1211. That is, features that have been identified for customer and the geographic location(s) associated with the transaction, these features are weighted, and then weighted feature values are aggregated (e.g., combined via adding, etc.) to create the final risk score.

Referring back to FIG. 11B, in one embodiment, output matrix 1112 is a consolidated feature set. In one embodiment, a large number of observable quantities from the multi-dimensional input data are organized as signals. In some embodiments, each signal comprises a plurality of threat vectors measured simultaneously in a time unit. The collection of signals is organized as a financial genome in which various threat vectors are linked by their similarity. The similarity is a measure imposed by the user. A threat diffusion similarity measure imposes a similarity relationship between any two data points by computing all combinations among pairs of data points. In one embodiment, these threat vectors 1112 are clustered using similarity measures that characterize different behavioral patterns, such that all the normal activities are inside “safe” clusters and all anomalies are outside the safe clusters. Various local criteria of linkage between data points lead to distinct genomic expressions. In these financial genomes, the user can redefine relevance via a similarity measure, and in this way filter away unrelated information. In one embodiment, self-organization of threat vectors is achieved through local similarity modeling.

Output matrix 1112 is fed into matrix processor 1113, which uses natural language processing, to convert output matrix 1112 into transaction classification reasoning logic 1123. Transaction classification reasoning logic 1123 is an explanation of the features that make up the pattern that was deemed suspicious. That is, transaction classification reasoning logic 1123 is the path the system took to arrive at the conclusion that the transaction has been deemed bad.

Subsequently, transaction classification reasoning logic 1123 and total risk score 1122 are sent to a case analyst. In one embodiment, this information is encrypted and sent over network connection to the case analyst.

In one embodiment, transaction classification reasoning logic 1123 includes a prediction of next steps/actions in the transaction. In one embodiment, this is determined by the auto encoder.

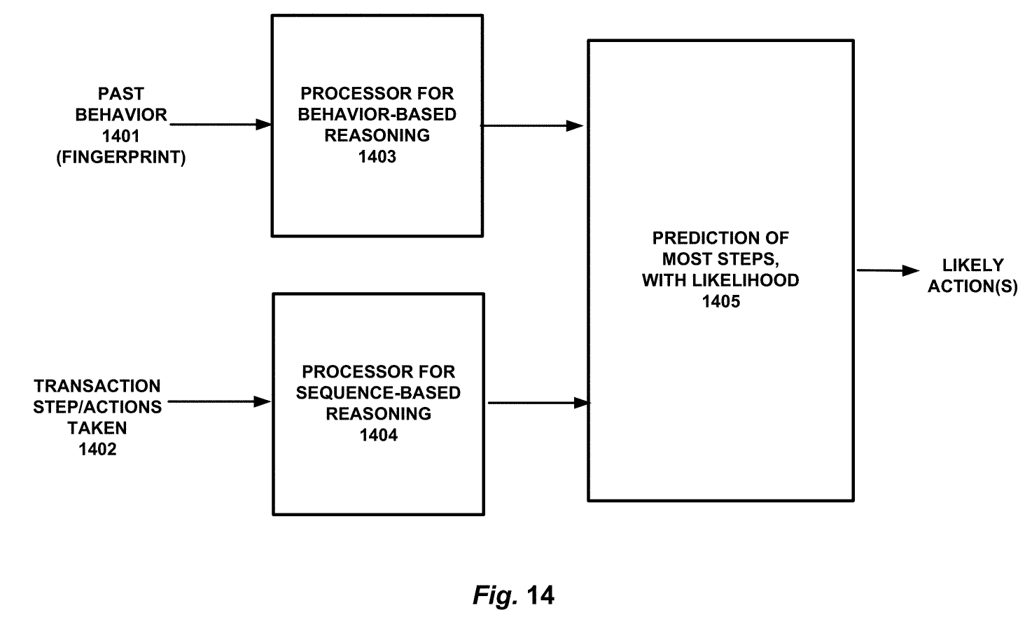

FIG. 14 is a data flow diagram of one embodiment of a process for predicting the next steps in a transaction. Referring to FIG. 14, past behavior (e.g., fingerprints) 1401 are input to a processor 1403 for behavior-based reasoning to identify the behavior associated with an individual as being suspicious or indicative of bad behavior. The steps and/or actions in a transaction 1402 are input into a processor 1404 for sequence-based reasoning to identify time-based behavior over a period of time to determine if there are correlations to patterns of financial activities that are being monitored. In one embodiment, processor 1404 uses a temporal statistical model to determine such patterns based on the customer and their accounts such that the patterns are determined at the customer level and the account level. By identifying such patterns and determining that they overlap with patterns associated with suspicious activity or bad behavior, a determination can be made that the activities of the individual should be brought to the attention of a case analyst.

In one embodiment, outputs of both processors 1403 and 1404 are input into prediction module 1405 that is able to predict the likely next steps of an individual based on their identified behavior patterns and the sequence based patterns that have been identified.

In one embodiment, the input to prediction module 1405 comprises the following scenarios codified into financial genome as a sparse data representation using auto encoder 1111:
(a) the scenario “Enormous ATM Withdrawal Activity” identifies those ATM withdrawals that indicate potential for suspicious activity. This scenario helps to detect withdrawal activity that sums to unusually large amounts. Once the illicit funds are washed within the financial ecosystem, cash withdrawals are an easy way of getting “clean” money back in to hands of the suspicious actor;
(b) the scenario “Surge in Beneficiary Account Activity” identifies those transactions where many different originator accounts are sending money to the same beneficiary account. When this type of activity is detected, it indicates a suspicious network that is working together to commit fraudulent activity;
(c) the scenario “Surge in Originator Account Activity” identifies those transactions where one originator account is sending money to a number of unique beneficiary accounts. When this type of activity is detected, it indicates a suspicious network that is working together to commit fraudulent activity;
(d) the scenario Enormous Cash Deposit Activity identifies those cash deposits that have the potential to be part of some suspicious activity. In one embodiment, the activity is either be a single cash deposit or it could be a collection of cash deposits. The cash deposits are aggregated at both the account level, as well as, the customer level;
(e) the scenario “Enormous Cash Withdrawals Activity” identifies those cash withdrawals that have the potential to be part of some suspicious activity. The activity could either be a single cash withdrawal or it could be a collection of cash withdrawals. The cash withdrawals are aggregated at both the account level, as well as, the customer level;
(f) the scenario “Surge in Inflow and Outflow of Funds Through Account” indicates those accounts which are potentially being used for fraudulent activity. In one embodiment, the scenario analyzes funds flowing in and out of the account within a specific time period. Primarily, such accounts have bursts of activity within a predetermined time period (e.g., a short time period) and then remain quiet for some time;
(g) the scenario “Ambiguous Payment Instructions” identifies wire transactions which contain cryptic wire messages;
(h) the scenario complex system of transactions identifies the account that is the source of a network involved in creating a complex web of transactions. Suspicious actors prefer creating multiple layers of activity to make it difficult for detection systems and investigators to identify the flow of funds. This scenario attempts to identify the source account by tracing a graph of transactions. In one embodiment, it leverages a graph-based model to traverse the complex network. Identifying the source account helps bring down the entire money laundering network;
(i) the scenario Dormant Activity identifies accounts that play the role of a dormant account, where dormant accounts are generally quiet accounts, and money is neither flowing in or out of the accounts for long periods of time. When there is a surge in activity within a dormant account, the scenario identifies the account as a potential suspicious account;
(j) suspicious actors always attempt to hide their associations to any suspicious activity. By regularly changing the ownership structure of the account, they can prevent the Customer Identification Program (CIP) from aggregating all information about the owner of the account. Additionally, suspicious actors may attempt to join an account as a secondary owner. Generally, the primary owners of such accounts are in a good standing with the financial institution and suspicious actors leverage such accounts to escape customer due diligence processes. In one embodiment, the ownership of an account is changed by either adding or removing (i) beneficiaries, (ii) joint owners, and (iii) power of attorneys;
(k) the scenario New Account Indicators identifies new accounts at a financial institution, which are considered as always having a higher risk. Sometimes suspicious actors open many new accounts in a bank, quickly commit fraudulent activity and close the account. The fraud that occurs within the first ninety days of account opening is termed as new account fraud;
(l) the scenario “Suspicious Customer Attributes” identifies customers with attributes that are marked as red flags. The attributes to be identified as red flags are dependent on the policies set by the financial institution, a state government and the federal government. In one embodiment, the KYC (Know Your Customer) screening process gathers information on customers during the account opening phase. It is during this time that the red flags are identified. Examples of customer attributes that are considered as red flags: (i) Politically Exposed Person, (ii) Foreign Financial Official, (iii) Is on a Watchlist, (iv) Is on a Blacklist, (v) Has a Non Physical Address, (vi) Is a Non-Resident, (vii) Has a Suspicious Activity Report filed, (viii) Has a Criminal Record, (ix) Has a Recalcitrant Account, (x) Has a Blacklisted Account, (xi) Has an Income to Expense Mismatch, (xii) Has a Risky Occupation, and (xiii) Has a Risky Business. The higher the number of red flags identified, the higher the suspicious level of the customer is;
(m) the scenario Significant Changes to Account Balance Over a Long Period identifies accounts which have been used to move large amounts of money over long periods of time. In this scenario, the key is to use a long time period. There are cases where suspicious actors are patient and transfer small sums of money over long periods of time. If the time periods that are relatively short, there is a high chance that this type of suspicious activity will be missed. This scenario analyzes large transaction amounts over a long time periods;
(n) the scenario Surge in Inflow and Outflow of Funds Through Entity identifies customers who leverage all of their accounts to move large sums of money over short periods of time. The suspicious actor leverages all of his/her accounts to move small amounts in large quantities. This activity is done to avoid any of the actor's accounts to be flagged as suspicious. If a single account is analyzed individually, it is possible that no alerts will be triggered. BBy analyzing the transactions at the customer level, this scenario helps in detecting such activities;
o) the scenario Multiple Branch Operation identifies customers who might mask large deposits across multiple accounts located in multiple branches. This breakdown of a large sum into smaller chunks could be an indicator of suspicious activity as the customer is intending to hide the huge sum by depositing smaller chunks in multiple branches. This scenario flags deposits made to multiple accounts, at multiple branches by the same customer; and
(p) the scenario Customer Identity Discovery identifies accounts owned by different customers that use the same identity information. In one embodiment, customers that provide the same information for Name, Phone number, Addresses, Social Security Number, etc., are flagged as they might be using a stolen identity. Identity Theft is a serious crime and this scenario flags customers who participate in such illicit activities. The scenario is designed to pardon customers with same address information when they belong to the same family. Exceptions can be made in the system depending upon the financial institution's requests. Identity information includes: (i) Name, (ii) Surname, (iii) Address, (iv) Phone Number, and (v) Social Security Number/Identification Number.

In other embodiments, the following threat vectors for correspondent banks are computed by auto encoder 1111 from the incoming inter- and intra-banking activities:
(a) the correspondent banking scenario Small Incremental Transfers for Beneficiary identifies transactions that have been structured in a way to avoid detection by money laundering tracking systems. Suspicious actors attempt to avoid their transactions being triggered by tracking systems. They attempt to accomplish this by moving small amounts internationally. The scenario identifies structured transactions to a single beneficiary;
(b) the correspondent banking scenario Surge in Originator Activity identifies those transactions where one customer (originator) is sending money to a number of unique beneficiaries. When this type of activity is detected, it indicates a suspicious network that is working together to commit fraudulent activity;
(c) the correspondent banking scenario Surge in Beneficiary Activity identifies those transactions where many different originator are sending money to the same beneficiary. When this type of activity is detected, it indicates a suspicious network that is working together to commit fraudulent activity;
(d) the correspondent banking scenario Transfers from High-Risk Countries identifies beneficiaries who receive money from parties located in high-risk countries. Large transfers from countries that are on a sanctions list, black list, or watch list have the potential to be fraudulent activity. It is important to detect and report such activity to the Financial Institution;
(e) the correspondent banking scenario Transfers from High-Risk Financial Institutions (FI) identifies beneficiaries who receive money from parties that have accounts at high-risk FIs. FIs are also placed on black lists. Some FIs support fraudulent activity through their ecosystem and it is important to track transfers that emerge from such FIs;
(f) the correspondent banking scenario Surge in Transfer Activity from the Same Party identifies the originator that transfers money to the same beneficiary. The transactions identified with this scenario are always between two unique customers or party groups;
(g) the correspondent banking scenario Surge in Transfer Activity to the Same Party identifies the beneficiary that receives money from the same originator. The transactions identified with this scenario are always between two unique customers or party groups; and
(h) the correspondent banking scenario Ambiguous Payment Instructions identifies transactions that contain cryptic wire messages. Wire transactions with cryptic keywords could be an indicator for suspicious activity. Examples of cryptic messages are, “jack and jill went up the hill”, “On your coat tails”, “My best friend”, “kudos”, “<customer name>666”, “PO BOX dropped”, etc.

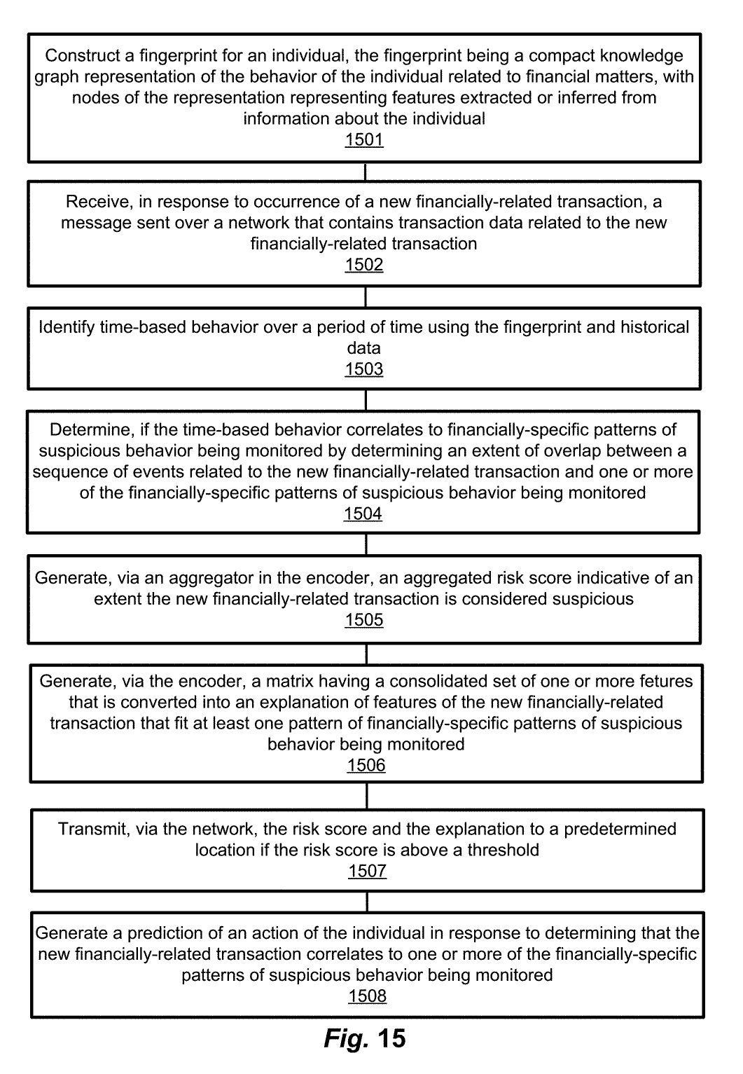

FIG. 15 is a flow diagram of one embodiment of a process for identifying suspicious financial transactions. The process is performed by processing logic that may comprise hardware (e.g., circuitry, dedicated logic, etc.), software (such as is run on a general purpose computer system or dedicated machine), firmware, or a combination of the three.

Referring to FIG. 15, the process begins by constructing a fingerprint for an individual, the fingerprint being a compact knowledge graph representation of the behavior of the individual related to financial matters, with nodes of the representation representing features extracted or inferred from information about the individual (processing block 1501). In one embodiment, this includes performing a feature discovery process that receives inputs in the form of user data provided by the individual, information indicative of associations of the individual, and information related to the individual obtained without input from the individual and extracts one or more of the features and infers one or more of the features, by applying one or more behavior models to the inputs. In one embodiment, constructing a fingerprint for an individual includes deriving hidden features in patterns, without a priori knowledge, by deriving hidden relationships among one or more of the identified features.

Processing logic receiving, in response to occurrence of a new financially-related transaction, a message sent over a network that contains transaction data related to the new financially-related transaction (processing block 1502).

Using the transaction data, processing logic identifies time-based behavior over a period of time using the fingerprint and historical data (processing block 1503). In one embodiment, identifying time-based behavior over a period of time comprises automatically extracting topologies of suspicious behavior by extracting and inferring features.

Next, using the fingerprint, processing logic determines, if the time-based behavior correlates to financially-specific patterns of suspicious behavior being monitored by determining an extent of overlap between a sequence of events related to the new financially-related transaction and one or more of the financially-specific patterns of suspicious behavior being monitored (processing block 1504). In on embodiment, determining if the time-based behavior correlates to financially-specific patterns of suspicious behavior being monitored by overlapping feature sets. In one embodiment, each of the patterns includes a temporal ordering of events.

Also processing logic generates, via an aggregator in the encoder, an aggregated risk score indicative of an extent the new financially-related transaction is considered suspicious (processing block 1505). In one embodiment, the aggregated risk score is an aggregation of a customer risk assessment, a transaction risk assessment, and a geo-location risk assessment.

Along with the aggregated risk score, processing logic generates, via the encoder, a matrix having a consolidated set of one or more features that is converted into an explanation of features of the new financially-related transaction that fit at least one pattern of financially-specific patterns of suspicious behavior being monitored (processing block 1506).

Then processing logic transmits, via the network, the risk score and the explanation to a predetermined location if the risk score is above a threshold (processing block 1507).

Optionally, processing logic generates a prediction of an action of the individual in response to determining that the new financially-related transaction correlates to one or more of the financially-specific patterns of suspicious behavior being monitored (processing block 1508).

There is a number of example embodiments described herein.

Example 1 is a computer-implemented method comprising: receiving a data set of financial activity data of multiple participants; configuring a deep neural network and thresholds, wherein the thresholds enable detection of what is within abnormal range of financial activity, patterns, and behavior over a period of time; converting the data set to a genome containing a node for each participant among the multiple participants; computing threat vectors for each node within a graphical representation of the genome that represents behavioral patterns of participants in financial activities, including determining when a key risk indicator (KRI) value computed for a particular threshold within the data set falls outside of a dynamically determined range bounded by thresholds, wherein the threat vectors automatically identify one or more of suspicious participants and suspicious activities in a provided financial activity pattern; and determining a particular edge in the network whose behavior falls outside the dynamically determined range associated with normal activity as a suspicious.

Example 2 is the method of example 1 that may optionally include receiving threat vectors as a data input and generating a knowledge graph utilizing a computer-based graph representation of first and second participants as nodes and relationship or activity between first and second participants as edges; and automatically identifying an anomaly as a potential suspicious actor and suspicious activity using the graph representation.

Example 3 is the method of example 1 that may optionally include accessing the plurality of threat vectors and thresholds to compute the key risk indicator values and determining when each key risk indicator value computed for a particular threshold within the data set falls outside of a dynamically determined range bounded by thresholds; computing a plurality of signals that are measured on a plurality of people, entities, and their associated activities, and wherein individuals and entities whose key risk indicators are anomalous in comparison with others; and wherein determining when a key risk indicator (KRI) value computed for a particular threshold within the data set falls outside of a dynamically determined range bounded by thresholds comprises completing a statistical pattern classification for detecting financial crime or fraudulent activities or events through the use of the genome, threat vectors, and the knowledge graph.

Example 4 is a system comprising: a network communication interface; a memory; one or more processor coupled to the memory and the network communication interface and operable to: receive a data set of financial activity data of multiple participants; configure a deep neural network and thresholds, wherein the thresholds enable detection of what is within abnormal range of financial activity, patterns, and behavior over a period of time, convert the data set to a genome containing a node for each participant among the multiple participants, compute threat vectors for each node within a graphical representation of the genome that represents behavioral patterns of participants in financial activities, including determining when a key risk indicator (KRI) value computed for a particular threshold within the data set falls outside of a dynamically determined range bounded by thresholds, wherein the threat vectors automatically identify one or more of suspicious participants and suspicious activities in a provided financial activity pattern, and determine a particular edge in the network whose behavior falls outside the dynamically determined range associated with normal activity as a suspicious.

Example 5 is a method comprising: constructing a fingerprint for an individual, the fingerprint being a compact knowledge graph representation of the behavior of the individual related to financial matters, with nodes of the representation representing entities extracted or inferred from information about the individual, and edges are activities between the first and second entities; receiving, in response to occurrence of a new financially-related transaction, a message sent over a network that contains transaction data related to the new financially-related transaction; identifying time-based behavior over a period of time using the fingerprint and historical data; determining, via an encoder having hardware and using the fingerprint, if the time-based behavior correlates to financially-specific patterns of suspicious behavior being monitored by determining an extent of overlap between a sequence of events related to the new financially-related transaction and one or more of the financially-specific patterns of suspicious behavior being monitored; generating, via an aggregator in the encoder, an aggregated risk score indicative of an extent the new financially-related transaction is considered suspicious; generating, via the encoder, a threat matrix having a consolidated set of one or more features that is converted into an explanation of features of the new financially-related transaction that fit at least one pattern of financially-specific patterns of suspicious behavior being monitored; transmitting, via the network, the risk score and the explanation to a predetermined location if the risk score is above a threshold.

Example 6 is the method of example 5 that may optionally include that the aggregated risk score is an aggregation of a customer risk assessment, a transaction risk assessment, and a geo-location risk assessment.

Example 7 is the method of example 5 that may optionally include performing a feature discovery process that receives inputs in the form of user data provided by the individual, information indicative of associations of the individual, and information related to the individual obtained without input from the individual and extracts one or more of the features and infers one or more of the features, by applying one or more behavior models to the inputs.

Example 8 is the method of example 7 that may optionally include that identifying time-based behavior over a period of time comprises automatically extracting topologies of suspicious behavior by extracting and inferring features.

Example 9 is the method of example 5 that may optionally include that determining if the time-based behavior correlates to financially-specific patterns of suspicious behavior being monitored by overlapping feature sets.

Example 10 is the method of example 5 that may optionally include that each of the patterns includes a temporal ordering of events.

Example 11 is the method of example 5 that may optionally include deriving hidden features in patterns, without a priori knowledge, by deriving hidden relationships among one or more of the identified features.

Example 12 is the method of example 5 that may optionally include generating a prediction of an action of the individual in response to determining that the new financially-related transaction correlates to one or more of the financially-specific patterns of suspicious behavior being monitored.

Example 13 is a non-transitory machine-readable medium having stored thereon one or more instructions, which if performed by a machine causes the machine to perform a method comprising: constructing a fingerprint for an individual, the fingerprint being a compact knowledge graph representation of the behavior of the individual related to financial matters, with nodes of the representation representing features extracted or inferred from information about the individual; receiving, in response to occurrence of a new financially-related transaction, a message sent over a network that contains transaction data related to the new financially-related transaction; identifying time-based behavior over a period of time using the fingerprint and historical data; determining, via an encoder having hardware and using the fingerprint, if the time-based behavior correlates to financially-specific patterns of suspicious behavior being monitored by determining an extent of overlap between a sequence of events related to the new financially-related transaction and one or more of the financially-specific patterns of suspicious behavior being monitored; generating, via an aggregator in the encoder, an aggregated risk score indicative of an extent the new financially-related transaction is considered suspicious; generating, via the encoder, a threat matrix having a consolidated set of one or more features that is converted into an explanation of features of the new financially-related transaction that fit at least one pattern of financially-specific patterns of suspicious behavior being monitored; transmitting, via the network, the risk score and the explanation to a predetermined location if the risk score is above a threshold.

Example 14 is the machine-readable medium of example 13 that may optionally include that the aggregated risk score is an aggregation of a customer risk assessment, a transaction risk assessment, and a geo-location risk assessment.

Example 15 is the machine-readable medium of example 13 that may optionally include that the method comprises performing a feature discovery process that receives inputs in the form of user data provided by the individual, information indicative of associations of the individual, and information related to the individual obtained without input from the individual and extracts one or more of the features and infers one or more of the features, by applying one or more behavior models to the inputs.

Example 16 is the machine-readable medium of example 15 that may optionally include that identifying time-based behavior over a period of time comprises automatically extracting topologies of suspicious behavior by extracting and inferring features.

Example 17 is the machine-readable medium of example 13 that may optionally include that determining if the time-based behavior correlates to financially-specific patterns of suspicious behavior being monitored by overlapping feature sets.

Example 18 is the machine-readable medium of example 13 that may optionally include that each of the patterns includes a temporal ordering of events.

Example 19 is the machine-readable medium of example 13 that may optionally include that the method further comprises deriving hidden features in patterns, without a priori knowledge, by deriving hidden relationships among one or more of the identified features.

Example 20 is the machine-readable medium of example 13 that may optionally include that the method further comprises generating a prediction of an action of the individual in response to determining that the new financially-related transaction correlates to one or more of the financially-specific patterns of suspicious behavior being monitored.

Example 21 is a system comprising: a network communication interface; a memory; one or more processor coupled to the memory and the network communication interface and operable to: construct a fingerprint for an individual, the fingerprint being a compact knowledge graph representation of the behavior of the individual related to financial matters, with nodes of the representation representing entities extracted or inferred from information about the individual, and edges are activities between the first and second entities, receive, in response to occurrence of a new financially-related transaction, a message sent over a network that contains transaction data related to the new financially-related transaction, identify time-based behavior over a period of time using the fingerprint and historical data, determine, via an encoder having hardware and using the fingerprint, if the time-based behavior correlates to financially-specific patterns of suspicious behavior being monitored by determining an extent of overlap between a sequence of events related to the new financially-related transaction and one or more of the financially-specific patterns of suspicious behavior being monitored, generate, via an aggregator in the encoder, an aggregated risk score indicative of an extent the new financially-related transaction is considered suspicious, generate, via the encoder, a threat matrix having a consolidated set of one or more features that is converted into an explanation of features of the new financially-related transaction that fit at least one pattern of financially-specific patterns of suspicious behavior being monitored, and transmit, via the network, the risk score and the explanation to a predetermined location if the risk score is above a threshold.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; etc.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

We claim:

1. A computer-implemented method comprising:
receiving a data set of financial activity data of multiple participants;
configuring a deep neural network and thresholds, wherein the thresholds enable detection of what is within abnormal range of financial activity, patterns, and behavior over a period of time;
converting the data set to a genome containing a node for each participant among the multiple participants;
computing threat vectors for each node within a graphical representation of the genome that represents behavioral patterns of participants in financial activities, including determining when a key risk indicator (KRI) value computed for a particular threshold within the data set falls outside of a dynamically determined range bounded by thresholds, wherein the threat vectors automatically identify one or more of suspicious participants and suspicious activities in a provided financial activity pattern; and
determining a particular edge in the network whose behavior falls outside the dynamically determined range associated with normal activity as a suspicious.

2. The method of claim 1, further comprising:
receiving threat vectors as a data input and generating a knowledge graph utilizing a computer-based graph representation of first and second participants as nodes and relationship or activity between first and second participants as edges; and
automatically identifying an anomaly as a potential suspicious actor and suspicious activity using the graph representation.

3. The method of claim 1, further comprising:
accessing the plurality of threat vectors and thresholds to compute the key risk indicator values and determining when each key risk indicator value computed for a particular threshold within the data set falls outside of a dynamically determined range bounded by thresholds;
computing a plurality of signals that are measured on a plurality of people, entities, and their associated activities, and wherein individuals and entities whose key risk indicators are anomalous in comparison with others; and
wherein determining when a key risk indicator (KRI) value computed for a particular threshold within the data set falls outside of a dynamically determined range bounded by thresholds comprises completing a statistical pattern classification for detecting financial crime or fraudulent activities or events through the use of the genome, threat vectors, and the knowledge graph.

4. A system comprising:
a network communication interface;
a memory;
one or more processor coupled to the memory and the network communication interface and operable to:
receive a data set of financial activity data of multiple participants;
configure a deep neural network and thresholds, wherein the thresholds enable detection of what is within abnormal range of financial activity, patterns, and behavior over a period of time,
convert the data set to a genome containing a node for each participant among the multiple participants,
compute threat vectors for each node within a graphical representation of the genome that represents behavioral patterns of participants in financial activities, including determining when a key risk indicator (KRI) value computed for a particular threshold within the data set falls outside of a dynamically determined range bounded by thresholds, wherein the threat vectors automatically identify one or more of suspicious participants and suspicious activities in a provided financial activity pattern, and
determine a particular edge in the network whose behavior falls outside the dynamically determined range associated with normal activity as a suspicious.

5. A method comprising:
constructing a fingerprint for an individual, the fingerprint being a compact knowledge graph representation of the behavior of the individual related to financial matters, with nodes of the representation representing entities extracted or inferred from information about the individual, and edges are activities between the first and second entities;
receiving, in response to occurrence of a new financially-related transaction, a message sent over a network that contains transaction data related to the new financially-related transaction;
identifying time-based behavior over a period of time using the fingerprint and historical data;
determining, via an encoder having hardware and using the fingerprint, if the time-based behavior correlates to financially-specific patterns of suspicious behavior being monitored by determining an extent of overlap between a sequence of events related to the new financially-related transaction and one or more of the financially-specific patterns of suspicious behavior being monitored;
generating, via an aggregator in the encoder, an aggregated risk score indicative of an extent the new financially-related transaction is considered suspicious;
generating, via the encoder, a threat matrix having a consolidated set of one or more features that is converted into an explanation of features of the new financially-related transaction that fit at least one pattern of financially-specific patterns of suspicious behavior being monitored;
transmitting, via the network, the risk score and the explanation to a predetermined location if the risk score is above a threshold.

6. The method defined in claim 5 wherein the aggregated risk score is an aggregation of a customer risk assessment, a transaction risk assessment, and a geo-location risk assessment.

7. The method defined in claim 5 further comprising performing a feature discovery process that receives inputs in the form of user data provided by the individual, information indicative of associations of the individual, and information related to the individual obtained without input from the individual and extracts one or more of the features and infers one or more of the features, by applying one or more behavior models to the inputs.

8. The method defined in claim 7 wherein identifying time-based behavior over a period of time comprises automatically extracting topologies of suspicious behavior by extracting and inferring features.

9. The method defined in claim 5 wherein determining if the time-based behavior correlates to financially-specific patterns of suspicious behavior being monitored by overlapping feature sets.

10. The method defined in claim 5 wherein each of the patterns includes a temporal ordering of events.

11. The method defined in claim 5 further comprising deriving hidden features in patterns, without a priori knowledge, by deriving hidden relationships among one or more of the identified features.

12. The method defined in claim 5 further comprising generating a prediction of an action of the individual in response to determining that the new financially-related transaction correlates to one or more of the financially-specific patterns of suspicious behavior being monitored.

13. A non-transitory machine-readable medium having stored thereon one or more instructions, which if performed by a machine causes the machine to perform a method comprising:
constructing a fingerprint for an individual, the fingerprint being a compact knowledge graph representation of the behavior of the individual related to financial matters, with nodes of the representation representing features extracted or inferred from information about the individual;
receiving, in response to occurrence of a new financially-related transaction, a message sent over a network that contains transaction data related to the new financially-related transaction;
identifying time-based behavior over a period of time using the fingerprint and historical data;
determining, via an encoder having hardware and using the fingerprint, if the time-based behavior correlates to financially-specific patterns of suspicious behavior being monitored by determining an extent of overlap between a sequence of events related to the new financially-related transaction and one or more of the financially-specific patterns of suspicious behavior being monitored;
generating, via an aggregator in the encoder, an aggregated risk score indicative of an extent the new financially-related transaction is considered suspicious;
generating, via the encoder, a threat matrix having a consolidated set of one or more features that is converted into an explanation of features of the new financially-related transaction that fit at least one pattern of financially-specific patterns of suspicious behavior being monitored;
transmitting, via the network, the risk score and the explanation to a predetermined location if the risk score is above a threshold.

14. The non-transitory machine-readable medium defined in claim 13 wherein the aggregated risk score is an aggregation of a customer risk assessment, a transaction risk assessment, and a geo-location risk assessment.

15. The non-transitory machine-readable medium defined in claim 13 wherein the method further comprises performing a feature discovery process that receives inputs in the form of user data provided by the individual, information indicative of associations of the individual, and information related to the individual obtained without input from the individual and extracts one or more of the features and infers one or more of the features, by applying one or more behavior models to the inputs.

16. The non-transitory machine-readable medium defined in claim 15 wherein identifying time-based behavior over a period of time comprises automatically extracting topologies of suspicious behavior by extracting and inferring features.

17. The non-transitory machine-readable medium defined in claim 13 wherein determining if the time-based behavior correlates to financially-specific patterns of suspicious behavior being monitored by overlapping feature sets.

18. The non-transitory machine-readable medium defined in claim 13 wherein each of the patterns includes a temporal ordering of events.

19. The non-transitory machine-readable medium defined in claim 13 wherein the method further comprises deriving hidden features in patterns, without a priori knowledge, by deriving hidden relationships among one or more of the identified features.

20. The non-transitory machine-readable medium defined in claim 13 wherein the method further comprises generating a prediction of an action of the individual in response to determining that the new financially-related transaction correlates to one or more of the financially-specific patterns of suspicious behavior being monitored.

21. A system comprising:
a network communication interface;
a memory;
one or more processor coupled to the memory and the network communication interface and operable to:
construct a fingerprint for an individual, the fingerprint being a compact knowledge graph representation of the behavior of the individual related to financial matters, with nodes of the representation representing entities extracted or inferred from information about the individual, and edges are activities between the first and second entities,
receive, in response to occurrence of a new financially-related transaction, a message sent over a network that contains transaction data related to the new financially-related transaction,
identify time-based behavior over a period of time using the fingerprint and historical data,
determine, via an encoder having hardware and using the fingerprint, if the time-based behavior correlates to financially-specific patterns of suspicious behavior being monitored by determining an extent of overlap between a sequence of events related to the new financially-related transaction and one or more of the financially-specific patterns of suspicious behavior being monitored,
generate, via an aggregator in the encoder, an aggregated risk score indicative of an extent the new financially-related transaction is considered suspicious,
generate, via the encoder, a threat matrix having a consolidated set of one or more features that is converted into an explanation of features of the new financially-related transaction that fit at least one pattern of financially-specific patterns of suspicious behavior being monitored, and
transmit, via the network, the risk score and the explanation to a predetermined location if the risk score is above a threshold.
